(19) United States
(12) Patent Application Publication
(10) Pub. No.: US 2008/0233404 A1
(43) Pub. Date: Sep. 25, 2008

(54) MICROREPLICATION TOOLS AND PATTERNS USING LASER INDUCED THERMAL EMBOSSING

(75) Inventors: Martin B. Wolk, Woodbury, MN (US); Mieczyslaw H. Mazurek, Roseville, MN (US); Khanh T. Huynh, Eagan, MN (US); John P. Baetzold, North St. Paul, MN (US); Yingbo Li, Woodbury, MN (US); Audrey A. Sherman, St. Paul, MN (US); Wendi J. Winkler, Minneapolis, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/689,853

(22) Filed: Mar. 22, 2007

(51) Int. Cl. B32B 9/04; B29C 35/08; B32B 15/04

(52) U.S. Cl. 428/411.1; 264/400; 428/457

(57) ABSTRACT

Laser induced thermal embossing (LITE) films used to make microreplication tools, liners, and products such as laser induced thermal imaging (LITI) donor films. The LITE tools or liners have a microstructured surface selectively imposed upon them as determined by an area of imaging the LITE films against one or more microreplication tools. An orientation between the laser imaging lines and LITE films can be selected to produce various microreplication patterns on the tools. The LITE tools can be made having a structure on structure pattern including a microstructured pattern with a nanostructured surface. The LITE liners can be combined with other films to form products. The LITE films can also be coated with a transfer layer to form a LITE donor film with a structured transfer layer.

### FIELD OF INVENTION

The present invention relates to microreplication tools and methods to make them using laser induced thermal embossing (LITE) films and laser induced thermal imaging (LITI) methods.

### BACKGROUND

Machining techniques, such as diamond turning and plunge electrical discharge machining, can be used to create a wide variety of work pieces such as microreplication tools. Microreplication tools are commonly used for extrusion processes, injection molding processes, embossing processes, casting processes, or the like, to create microstructures. The articles having microstructured surfaces may comprise optical films, abrasive films, adhesive films, mechanical fasteners having self-mating profiles, or any molded or extruded parts having microreplication features of relatively small dimensions, such as dimensions less than approximately 1000 microns.

The microstructured features can also be made by various other methods. For example, the structure of the master tool can be transferred onto other media, such as to a belt or web of polymeric material, by a cast and cure process from the master tool in order to form a production tool, which is then used to make the microstructures. Other methods such as electroforming can be used to copy the master tool. Other techniques of making tools include chemical etching, bead blasting, or other stochastic surface modification techniques.

### SUMMARY

A LITE film, consistent with the present invention, includes a substrate and a light-to-heat conversion layer overlaying the substrate. A surface of the LITE film is capable of bearing a microstructured surface selectively embossed thereon.

A method of fabricating a microreplication tool, consistent with the present invention includes the following steps: providing a LITE film comprising a substrate and a light-to-heat conversion layer overlaying the substrate; laminating the LITE film to a master tool comprising a pattern of microstructures with the light-to-heat conversion layer being in contact with the microstructures; pattern-wise imaging the LITE film to selectively expose the light-to-heat conversion layer; and removing the master tool to produce a microstructured pattern on the LITE film corresponding with the microstructures of the master tool.

### BRIEF DESCRIPTION OF DRAWINGS

The accompanying drawings are incorporated in and constitute a part of this specification and, together with the description, explain the advantages and principles of the invention. In the drawings,

FIG. 1 is a diagram of an exemplary LITE film prior to embossing;

FIGS. 2a-2c are diagrams illustrating a process of embossing a LITE film to produce a microreplication tool, liner, or product such as LITI donor film;

FIG. 3 is a diagram of an embossed liner and product;

FIG. 4 is a diagram of an embossed product made from the embossed liner;

FIG. 5a is a perspective diagram of a microreplication tool;

FIG. 5b is a perspective diagram of a LITE tool made using the microreplication tool shown in FIG. 5a;

FIG. 6a is a perspective diagram of three different microreplication tools;

FIG. 6b is a perspective diagram of a LITE tool made using the three microreplication tools shown in FIG. 6a;

FIGS. 7a-7f are diagrams illustrating a process of embossing a LITE film, while using a structure on structure pattern in the film or a corresponding tool, to produce a microreplication tool, liner, or product such as LITI donor film;

FIGS. 8a-8c are diagrams illustrating a LITI process of imaging an embossed a LITE film having a transfer layer in order to transfer a portion of the transfer layer to a permanent receptor;

FIG. 9a is a diagram illustrating a process for making a LITE tool using a 90° orientation of laser scanning;

FIG. 9b is an image of a sample LITE tool made using the scanning orientation shown in FIG. 9a;

FIG. 10a is a diagram illustrating a process for making a LITE tool using a 45° orientation of laser scanning; and

FIG. 10b is an image of a sample LITE tool made using the scanning orientation shown in FIG. 10a.

### DETAILED DESCRIPTION

Embodiments of the present invention include methods to generate complex tools for micro- and nano-replication processes. The methods involve combining aspects of precision laser exposure and LITE with conventional microreplication tools such as those made using precision diamond machining, Excimer Laser Machining of Flats (ELMoF), photolithographic patterning, or other techniques. LITE can be performed using virtually any microreplication tool surface and a LITE sheet or film having sufficient heat stability. The film is laminated to the microreplication tool and then exposed from the back with a laser. The result is a three dimensional embossed pattern that corresponds with the pattern of the microreplication tool at the laser exposure area.

LITE can be used to create many different microstructured films. For example, LITE can provide for a rapid method to create customizable holographic patterns on film substrates for security applications using a single holographic master (e.g., laminates for drivers licenses or credit cards). LITE can also be used to create microstructured films having various other optical properties based upon, for example, their microstructured optical elements. In addition, LITE offers the ability to combine elements from different MS tooling methods into one LITE tool.

LITE can also be used to make products from a master tool. The LITE film, after embossing, can form a microstructured master tool having a microreplicated pattern corresponding with the embossing. The LITE film as a master tool can be used to microreplicate a product having the inverse pattern from the tool, for example a protrusion in the master tool corresponds with an indentation in the product. Alternatively, the LITE film as a master tool can be used to make a microreplicated mold, which can then be used to make a product having the same microreplicated pattern as the master tool, or to make a more robust (metal) tool, for example by nickel electroforming having the inverse pattern. Electroforming is described in, for example, U.S. Pat. Nos. 4,478,769 and 5,156,863, which are incorporated herein by reference. The LITE film as a master tool can thus be used to produce positive and negative replicated products of the microreplicated pattern of the master tool.

The term “microreplication tool” means a tool having microstructured features, nanostructured features, or a combination of microstructured and nanostructured features from which the features can be replicated. The term “microstructured” refers to features of a surface that have at least one dimension (e.g., height, length, width, or diameter), and typically at least two dimensions, of less than one millimeter. The term “nanostructured” refers to features of a surface that have at least one dimension (e.g., height, length, width, or diameter) of less than one micron.

### LITE Film and Embossing Process

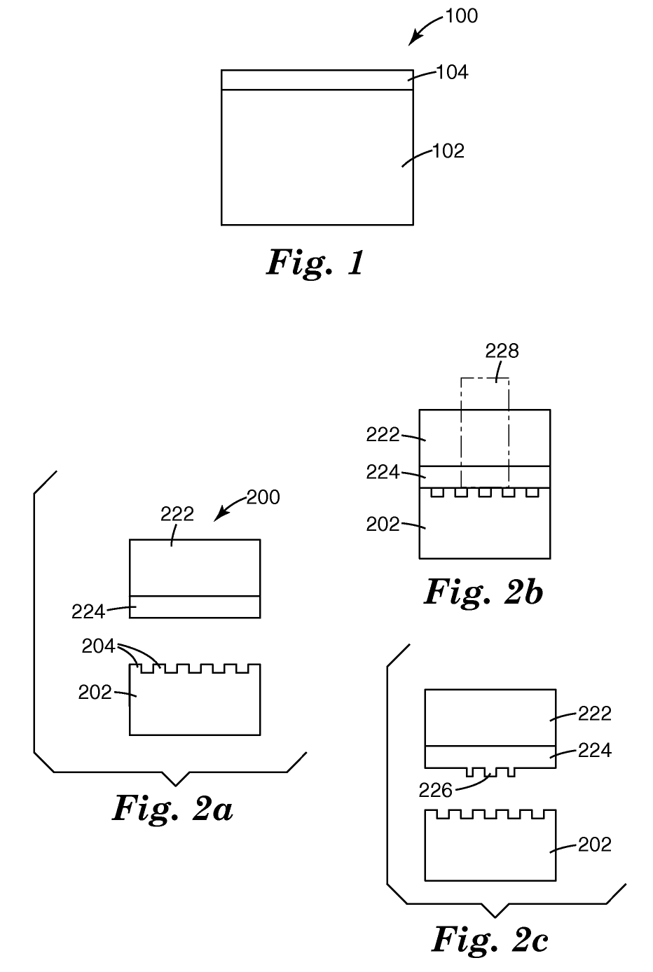

FIG. 1 is a diagram of an exemplary LITE film 100. Film 100 typically includes a substrate 102 and light-to-heat conversion (LTHC) layer 104. LITE is used to emboss the LTHC, creating on the LTHC layer a microstructured or nanostructured pattern or both.

The film substrate 102 provides support for the layers of the film 100. One suitable type of polymer film is a polyester film, for example, PET or polyethylene naphthalate (PEN) films. However, other films with sufficient optical properties can be used, if light is used for heating and embossing. The film substrate, in at least some instances, is flat so that uniform coatings can be formed. The film substrate is also typically selected from materials that remain substantially stable despite heating of any layers in the film (e.g., an LTHC layer). A suitable thickness for the film substrate ranges from, for example, 0.025 millimeters (mm) to 0.15 mm, preferably 0.05 mm to 0.1 mm, although thicker or thinner film substrates may be used.

The LTHC layer 104 typically includes a radiation absorber that absorbs incident radiation (e.g., laser light) and converts at least a portion of the incident radiation into heat to enable embossing of the LTHC layer. Alternatively, radiation absorbers can be included in one or more other layers of the LITE film in addition to or in place of the LTHC layer. Typically, the radiation absorber in the LTHC layer (or other layers) absorbs light in the infrared, visible, and/or ultraviolet regions of the electromagnetic spectrum. The radiation absorber is typically highly absorptive of the selected imaging radiation, providing an optical density at the wavelength of the imaging radiation in the range of 0.2 to 3, and preferably from 0.5 to 2. Suitable radiation absorbing materials can include, for example, dyes (e.g., visible dyes, ultraviolet dyes, infrared dyes, fluorescent dyes, and radiation-polarizing dyes), pigments, metals, metal compounds, metal films, and other suitable absorbing materials. Examples of other suitable radiation absorbers can include carbon black, metal oxides, and metal sulfides.

For imaging of the LITE film in order to emboss it, a variety of radiation-emitting sources can be used. For analog techniques (e.g., exposure through a mask), high-powered light sources (e.g., xenon flash lamps and lasers) are useful. For digital imaging techniques, infrared, visible, and ultraviolet lasers are particularly useful. Suitable lasers include, for example, high power (e.g. ≧100 mW) single mode laser diodes, fiber-coupled laser diodes, and diode-pumped solid state lasers (e.g., Nd:YAG and Nd:YLF). Laser exposure dwell times can be in the range from, for example, about 0.1 microsecond to 100 microseconds and laser fluences can be in the range from, for example, about 0.01 J/cm² to about 1 J/cm². In at least some instances, pressure or vacuum may be used to hold the LTHC layer in intimate contact with a microreplication tool. A radiation source may then be used to heat the LTHC layer or other layers containing radiation absorbers in an image-wise fashion (e.g., digitally or by analog exposure through a mask) to emboss the LTHC layer.

A microreplication tool can be used to generate LITE films by irradiating the films, when laminated to the microreplication tool, with an area of a laser exposure. The result is an embossed film with a structure corresponding with the microreplication structure of the tool in the areas of laser exposure. In addition, the process can be repeated with different tools, made from different MS techniques, to provide a single LITE tool with a number of different patterns.

FIGS. 2a-2c are diagrams illustrating use of LITE to make a microreplication tool using a LITE film. As shown in FIG. 2a, making a microreplication tool involves use of a film 200 and microreplication tool 202. Film 200 has a substrate 222 and an additional layer 224 such as an LTHC layer, which may correspond with substrate 102 and LTHC layer 104. Microreplication tool 202 has microstructures 204. To make the LITE microreplication tool, as illustrated in FIG. 2b, film 200 is laminated to tool 202 with microstructures 204 in contact with LTHC layer 224, and the film 200 is then imaged against tool 202, while laminated to it, using a laser beam 228 and a thermal imaging process such as that described in the present specification. Following imaging and removal of imaged film 200 from tool 202, LTHC layer 224 has a microreplication pattern 226 corresponding with the imaged part of the microstructures on tool 202, as illustrated in FIG. 2c. The imaged film with the microreplication pattern can subsequently be used, for example, as a reusable tool, or it can be used to make a metal copy or replica of the imaged film.

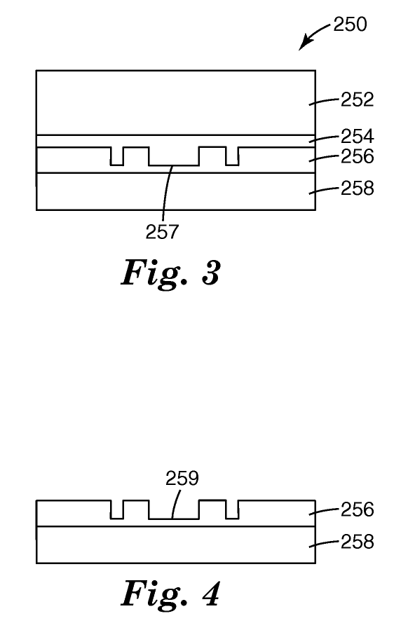

FIG. 3 is a diagram of a film construction 250 including an embossed liner and product. The embossed liner is composed of a substrate 252 and structured LTHC 254, which may correspond with substrate 102 and LTHC layer 104 and can be embossed using the techniques described above to impart a structure 257 within it. The product is composed of a substrate 258 and a material layer 256, which becomes structured upon lamination or application of the embossed liner to it. FIG. 4 is a diagram of an embossed product made from the embossed liner. The embossed product is composed of substrate 258 and material 256 having a structure 259 imparted from structured LTHC 254 of the liner. An example of a structured liner is described in U.S. Pat. No. 6,838,150, which is incorporated herein by reference.

### LITE Film for Microreplication Tools

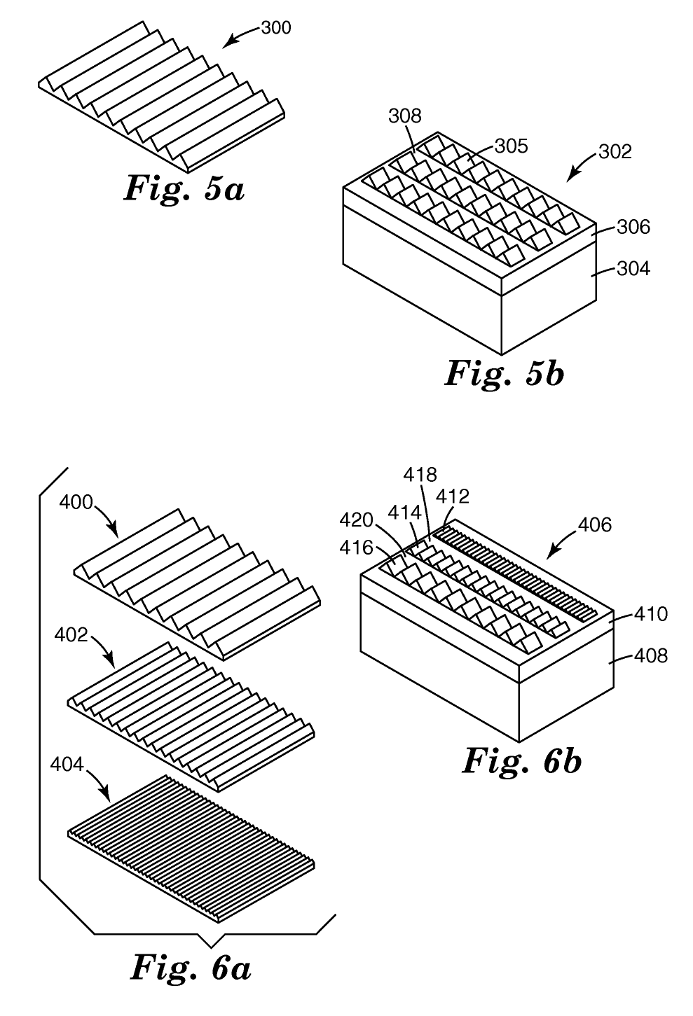

FIG. 5a is a perspective diagram of a microreplication tool 300 having microstructured prisms. FIG. 5b is a perspective diagram of a LITE tool 302 made using the microreplication tool 300. In particular, the microreplication tool 302 comprises a LITE film having a substrate 304 and an additional layer 306 such as an LTHC layer, which may correspond with substrate 102 and LTHC layer 104. Tool 302 can be made using the same or a similar process as described with respect to FIGS. 2a-2c. In particular, to make LITE tool 302, it is laminated to tool 300 with the microstructured prisms in contact with LTHC layer 306, and it is then imaged against tool 300. Following the imaging, layer 306 is embossed with microstructures 305 separated by a non-imaged portion 308.

A variation of the LITE process involves the use of multiple microreplication tools having different microstructured patterns to create a more complex LITE tool. FIG. 6a is a perspective diagram of three microreplication tools 400, 402, and 404, each having microstructured prisms with a different pitch and height. FIG. 6b is a perspective diagram of a LITE tool 406 made using the microreplication tools shown in FIG. 6a. In particular, microreplication tool 406 comprises a LITE film having a substrate 408 and an additional layer 410 such as an LTHC layer, which may correspond with substrate 102 and LTHC layer 104. LITE tool 406 can be made using the same or a similar process as described with respect to FIGS. 2a-2c. In particular, to make LITE tool 406, it is sequentially laminated and imaged against tools 400, 402, and 404 with the microstructured prisms in contact with LTHC layer 410 during the imaging. Following the imaging, layer 410 is embossed with microstructures 412, 414, and 416 corresponding with tools 404, 402, and 400, respectively, and separated by non-imaged portions 418 and 420.

LITE Film with Structure on Structure

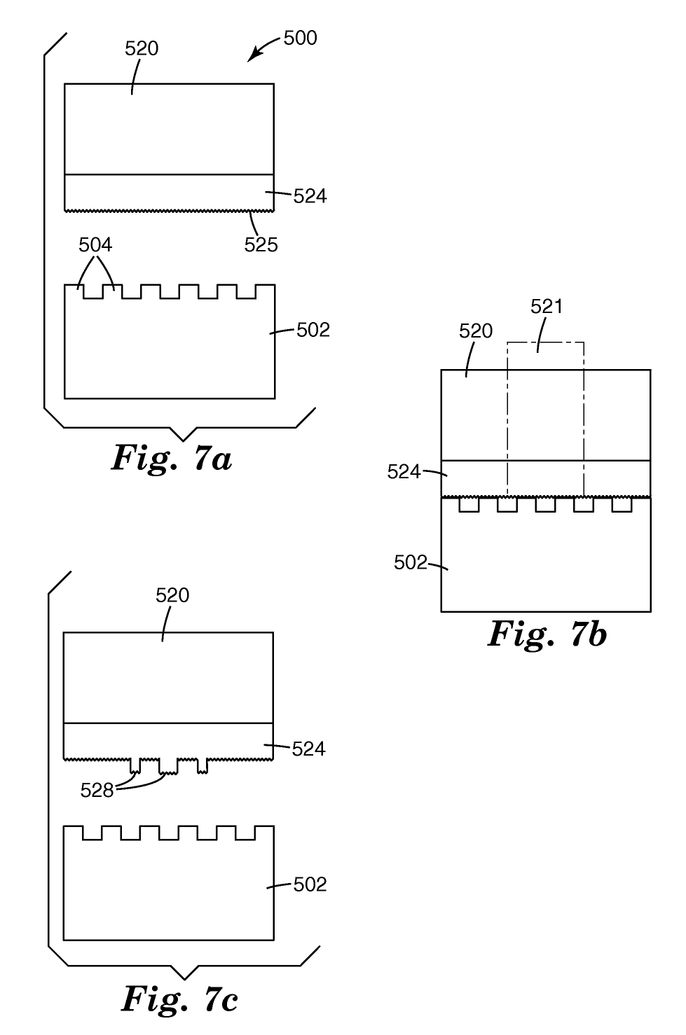

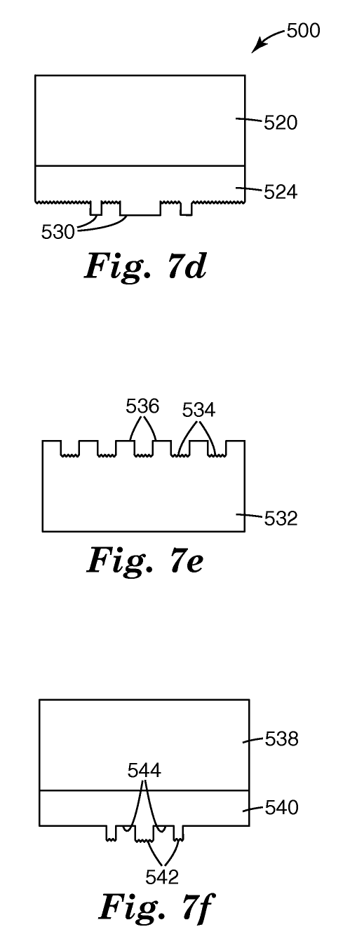

Another variation of the LITE process enables the creation of structure on structure arrays or patterns comprising micron scale features, such as prisms, with nanostructured features on their surface. As an example, the nanostructured features can include one- or two-dimensional diffraction gratings. FIGS. 7a-7c are diagrams illustrating use of LITE to make a microreplication tool having a structure on structure pattern. As shown in FIG. 7a, making a structure on structure microreplication tool involves use of a film 500 and microreplication tool 502. Film 500 has a substrate 520 and an additional layer 524, such as an LTHC layer, which may correspond with substrate 102 and LTHC layer 104. LTHC layer 524 has a nanostructured surface 525, and microreplication tool 502 has microstructures 504. To make the LITE microreplication tool, as illustrated in FIG. 7b, film 500 is laminated to tool 502 with microstructures 504 in contact with LTHC layer 524, and the film 500 is then imaged against tool 502, while laminated to it, using a laser beam 521 and a thermal imaging process such as that described in the present specification. Following imaging and removal of imaged film 500 from tool 502, LTHC layer 524 has a microreplication pattern 528 having a nanostructured surface and corresponding with the imaged part of the microstructures on tool 502, as illustrated in FIG. 7c.

FIGS. 7d-7f illustrates alternatives to the structure on structure patterns. FIG. 7d is a diagram of a LITE film 500 embossed against tool 502 where certain nanostructures are removed in areas 530 during the embossing process as described with respect to FIG. 7b. In particular, a laser beam 521 of sufficient energy can be used to cause destruction of the nanostructured features in areas 530 imaged against tool 502. In another variation, as shown in FIG. 7e, a tool 532 has a structure on structure pattern including microstructured features 536 and nanostructured features 534 between or among the microstructured features. FIG. 7f is a diagram illustrating a LITE film, including a substrate 538 and an additional layer 540 such as an LTHC, embossed using tool 532 and the embossing process as described above. After embossing against tool 532, the LITE film has nanostructured features 542 on microstructured features separated by spaces 544 corresponding with microstructured features 536 on tool 532.

### LITE Film in a LITI Process

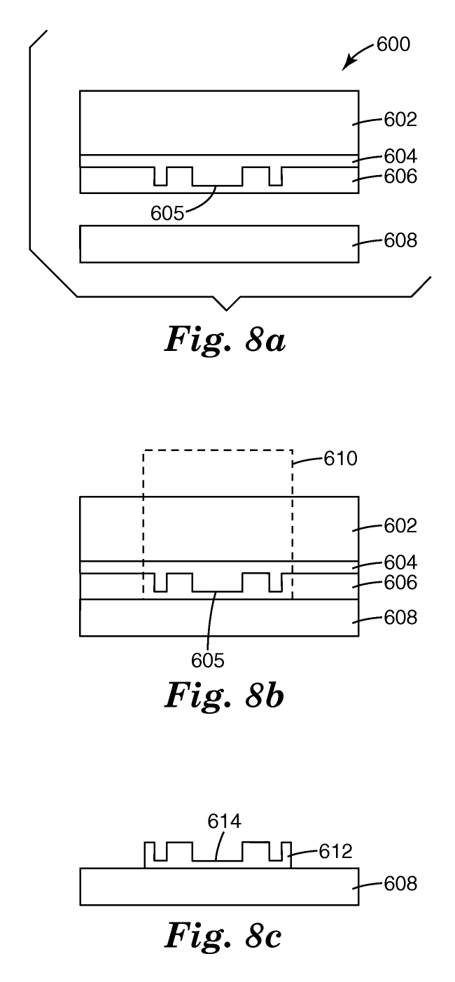

FIGS. 8a-8c are diagrams illustrating a LITI process of imaging an embossed LITE film 600 having a transfer layer 606 in order to transfer a portion of the transfer layer to a receptor 608. As shown in FIG. 8a, LITE film 600 is composed of an embossed LITE film coated with a transfer layer. The LITE film is composed of a substrate 602 and an LTHC layer 604 having structure 605 made using a process of imaging it against a microreplication tool as described above. A transfer layer 606 is applied to structured LTHC layer 604. During imaging, as shown in FIG. 8b, the LITE film is held in intimate contact with the receptor with the transfer layer held against receptor 608, and a laser beam 610 irradiates the LITE film causing transfer of a portion of the transfer layer 606 to receptor 608. As shown in FIG. 8c, when the LITE film is removed, a transferred portion 612 of transfer layer 606 remains on receptor 608, and the transferred portion 612 has a structure 614 as imparted by structure 605 in LTHC 604 of the LITE film.

Various layers of an exemplary LITI donor film, and methods to image it, are more fully described in U.S. Pat. Nos. 6,866,979; 6,586,153; 6,468,715; 6,284,425; and 5,725,989, all of which are incorporated herein by reference as if fully set forth.

Film 600 can have an optional interlayer between LTHC layer 606 and embossing layer 608. The optional interlayer may be used in the thermal donor to minimize damage and contamination of the transferred portion of the layer and may also reduce distortion in the transferred portion of the layer. The interlayer may also influence the adhesion of the transfer layer to the rest of the thermal transfer donor. Typically, the interlayer has high thermal resistance. Preferably, the interlayer does not distort or chemically decompose under the imaging conditions, particularly to an extent that renders the transferred image non-functional. The interlayer typically remains in contact with the LTHC layer during the transfer process and is not substantially transferred with the transfer layer. Suitable interlayers include, for example, polymer films, metal layers (e.g., vapor deposited metal layers), inorganic layers (e.g., sol-gel deposited layers and vapor deposited layers of inorganic oxides (e.g., silica, titania, and other metal oxides)), and organic/inorganic composite layers. Organic materials suitable as interlayer materials include both thermoset and thermoplastic materials. Suitable thermoset materials include resins that may be crosslinked by heat, radiation, or chemical treatment including, but not limited to, crosslinked or crosslinkable polyacrylates, polymethacrylates, polyesters, epoxies, and polyurethanes. The thermoset materials may be coated onto the LTHC layer as, for example, thermoplastic precursors and subsequently crosslinked to form a crosslinked interlayer. The interlayer may contain additives, including, for example, photoinitiators, surfactants, pigments, plasticizers, and coating aids.

The transfer layer 606 typically includes one or more layers for transfer to receptor 608. These one or more layers may be formed using organic, inorganic, organometallic, and other materials. Organic materials include, for example, small molecule materials, polymers, oligomers, dendrimers, and hyperbranched materials. The thermal transfer layer can include a transfer layer that can be used to form, for example, light emissive elements of a display device, electronic circuitry, resistors, capacitors, diodes, rectifiers, electroluminescent lamps, memory elements, field effect transistors, bipolar transistors, unijunction transistors, metal-oxide semiconductor (MOS) transistors, metal-insulator-semiconductor transistors, charge coupled devices, insulator-metal-insulator stacks, organic conductor-metal-organic conductor stacks, integrated circuits, photodetectors, lasers, lenses, waveguides, gratings, holographic elements, filters for signal processing (e.g., add-drop filters, gain-flattening filters, cut-off filters, and the like), optical filters, mirrors, splitters, couplers, combiners, modulators, sensors (e.g., evanescent sensors, phase modulation sensors, interferometric sensors, and the like), optical cavities, piezoelectric devices, ferroelectric devices, thin film batteries, or combinations thereof, for example the combination of field effect transistors and organic electroluminescent lamps as an active matrix array for an optical display. Other items may be formed by transferring a multi-component transfer assembly or a single layer.

Permanent receptor 608 for receiving at least a portion of transfer layer 606 may be any item suitable for a particular application including, but not limited to, transparent films, display black matrices, passive and active portions of electronic displays, metals, semiconductors, glass, various papers, and plastics. Examples of receptor substrates include anodized aluminum and other metals, plastic films (e.g., PET, polypropylene), indium tin oxide coated plastic films, glass, indium tin oxide coated glass, flexible circuitry, circuit boards, silicon or other semiconductors, and a variety of different types of paper (e.g., filled or unfilled, calendered, or coated).

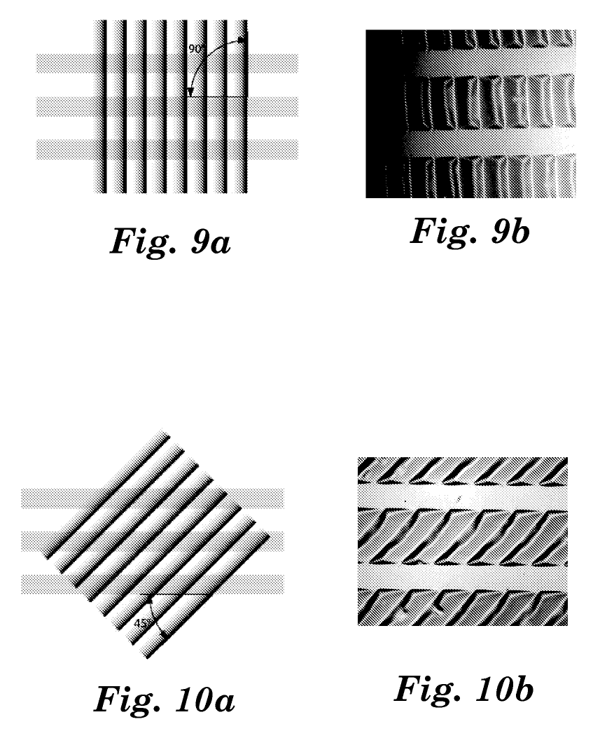

FIG. 9a is a diagram illustrating a process for making a LITE tool using a 90° orientation of laser scanning, and FIG. 9b is an image of a sample LITE tool having microstructures with a 100 micron horizontal pitch and made using the scanning orientation shown in FIG. 9a. FIG. 10a is a diagram illustrating a process for making a LITE tool using a 45° orientation of laser scanning, and FIG. 10b is an image of a sample LITE tool having microstructures with a 100 micron diagonal pitch and made using the scanning orientation shown in FIG. 10a. These tools can be made using a process of imaging a LITE film against a microreplication tool as described above. FIGS. 9a, 9b, 10a, and 10b also illustrate how the registration of the laser scan lines and the tool can be controlled in order to emboss various patterns of features into a LITE film. For example, in some embodiments the tool has a high resolution regular array of microstructured features, the LITE film has no information patterned within it, and the laser pattern has high positional accuracy; in those embodiments, the resulting pattern in the LITE film after embossing includes high positional accuracy with high resolution embossed features, preferably smaller than the laser scan lines. Other embodiments may require registration of the laser system with a tool for embossing a LITE film having various configurations of embossed features. Once the LITE film has been embossed, it can include fiducial marks, or any other type of registration marks, for subsequently aligning the laser system with the LITE film according to the embossed pattern. An example of the use of fiducials in a web-based system is described in U.S. Pat. No. 7,187,995, which is incorporated herein by reference.

### EXAMPLES

### LITE Film 1

LITE Film 1, comprising two coated layers on PET film was prepared in the following manner. An LTHC was applied on 2.88 mil thick PET film substrate (M7Q film, DuPont Teijin Films, Hopewell Va.) by coating LTHC-1 (Table 1) using a reverse microgravure coater (Yasui Seiki CAG-150). The coating was dried in-line and photocured under ultraviolet radiation in order to achieve an LTHC dry thickness of approximately 2.7 microns. The cured coating had an optical density of approximately 1.18 at 1064 nanometers (nm).

A clear coat was applied to the LTHC layer by coating CC-1 (Table 2) using a reverse microgravure coater (Yasui Seiki CAG-150). The coating was dried in-line and photocured under ultraviolet radiation in order to achieve a dry clear coat thickness of approximately 1.1 microns.

TABLE 1
LTHC-1 Formulation

| | | Solution | | |
|---|---|---|---|---|
| | | Fraction | Solids Fraction | |
| Trade Name | Supplier | (wt %) | (wt %) | Description |
| Raven 760 | Columbian | 3.56 | 12.96 | carbon black |
| | Chemicals Co. | | | |
| Butvar B-98 | Solutia | 0.64 | 2.31 | polyvinyl butyral resin |
| Joncryl 67 | Johnson Polymer | 1.90 | 6.91 | modified styrene acrylic |
| | | | | polymer |
| Disperbyk 161 | Byk-Chemie USA | 0.32 | 1.17 | dispersant |
| Ebecryl 629 | UCB Chemicals | 12.09 | 43.95 | epoxy novolac acrylate |
| | | | | diluted with TMPTA |
| | | | | (trimethylolpropane |
| | | | | triacrylate) and HEMA |
| | | | | (2-hydroxy ethyl |
| | | | | methacrylate) |
| Elvacite 2669 | Lucite International | 8.06 | 29.30 | acrylic resin |
| Irgacure 369 | Ciba Specialty | 0.82 | 2.97 | photoinitiator |
| | Chemicals | | | |
| Irgacure 184 | Ciba Specialty | 0.12 | 0.44 | photoinitiator |
| | Chemicals | | | |
| 2-butanone | | 45.31 | | solvent |
| 1-methoxy-2- | | 27.19 | | solvent |
| propanol acetate | | | | |

TABLE 2
CC-1 Formulation

| | | Solution | Solids | |
|---|---|---|---|---|
| | | Fraction | Fraction | |
| Trade Name | Supplier | (wt %) | (wt %) | Description |
| Butvar B-98 | Solutia | 0.93 | 4.64 | polyvinyl |
| | | | | butyral |
| | | | | resin |
| Joncryl 67 | Johnson | 2.78 | 13.92 | modified styrene |
| | Polymer | | | acrylic polymer |
| SR351HP | Sartomer | 14.85 | 74.24 | trimethylolpropane |
| | | | | triacrylate |
| Irgacure 369 | Ciba Specialty | 1.25 | 6.27 | photoinitiator |
| | Chemicals | | | |
| Irgacure 184 | Ciba Specialty | 0.19 | 0.93 | photoinitiator |
| | Chemicals | | | |
| 1-methoxy-2- | | 32.00 | | solvent |
| propanol (PM) | | | | |
| 2-butanone | | 48.00 | | solvent |
| (MEK) | | | | |

### LITE Film 2

LITE Film 2, comprising a single coated layer on PET film was prepared in the following manner. An LTHC layer was applied on 2.88 mil thick PET film substrate (M7Q film, DuPont Teijin Films, Hopewell Va.) by coating LTHC-2 (Table 3) using a reverse microgravure coater (Yasui Seiki CAG-150). The coating was dried in-line in order to achieve an LTHC dry thickness of approximately 3.7 microns. The dry coating had an optical density of approximately 3.2 at 808 nm.

TABLE 3
LTHC-2 Formulation

| | | Solution | Solids | |
|---|---|---|---|---|
| | | Fraction | Fraction | |
| Trade Name | Supplier | (wt %) | (wt %) | Description |
| Butvar B-76 | Solutia | 9.94 | 95.6 | polyvinyl butyral |
| | | | | resin |
| ProJet 830 LDI | Avecia | 0.46 | 4.4 | Infrared absorber |
| 2-butanone (MEK) | | 89.6 | | solvent |

### Nickel Electroform Tool

The patterned silicon wafer master was fabricated on a standard orientation 4 inch silicon wafer which was coated with Shipley 1813 photoresist (Rohm and Haas Electronic Materials, Newark, Del.). The resist was patterned with small square arrays of 5 micron linear features by way of contact photolithography using a standard I-line mask aligner (Quintel, San Jose, Calif.) and an E-beam written chrome on glass phototool. Standard development techniques for Shipley resists were used, although no final hard bake was performed on the resist. The sample was then etched in a reactive ion etch tool equipped with an inductively coupled plasma generator (Oxford Instruments, Eynsham, England). The sample was etched for 2 minutes to an approximate etch depth of 0.5 micron using C₄F₈ and O₂, an RF power of 70 W, an ICP power of 1600 W, and a pressure of 5.5 mTorr. The sample was then stripped of the resist using Shipley 1165 resist stripper in a heated ultrasonic photoresist stripper bath, yielding the master tool.

The master tool was plated with electrolytic nickel to a thickness of approximately 25 mils. Prior to nickel plating, 1000 Å of vapor coated nickel was deposited on the surface in order to make the wafers conductive. The nickel plating was performed in two steps consisting of a preplate of 6 hours with a low deposition rate to ensure that a uniform conductive layer of nickel was established, followed by a more rapid deposition to achieve the target thickness value of 25 mils. The electroforming yielded the nickel electroform tool with arrays of 5 micron wide linear features having a uniform height of approximately 1.29 microns (as determined by AFM analysis).

### LITE Procedure

In order to create a LITE tool, a LITE film was brought into intimate contact with a structured tool. Air between the film and tool was removed with a vacuum chuck assembly, and the film-tool laminate was exposed to laser radiation through the support layer (substrate) of the film. For laser system A exposure (λ=1064 nm), the scan velocity was 0.635 m/s, spot power was 1 W in the image plane, and the dose was 0.85 J/cm². For laser system B exposure (λ=808 nm), the scan velocity was 1.0 m/s, spot power was 1.3 W and dose was 1.3 J/cm².

TABLE 4

| | | | | Tool |
|---|---|---|---|---|
| Example | LITE Film | Laser System | Structured Tool | Orientation |
| 1 | 1 | A | IDF | 0° |
| 2 | 1 | A | IDF | 45° |
| 3 | 1 | A | nickel electroform | N/A |
| 4 | 2 | B | nickel electroform | N/A |

Atomic force microscopy (AFM) in tapping mode was used to characterize embossed features of LITE film 2 and corresponding features of the nickel electroform and IDF. The instrument used for analysis of TMF film and corresponding LITE film 2 was a Digital Instruments Dimension 3100 SPM. The instrument used for analysis of nanotool and corresponding LITE film 2 was a Digital Instruments Dimension 5000 SPM. The probes used were Olympus OTESP single crystal silicon levers with a force constant of ˜40 N/M. The setpoint value was set to 75% of the original free space amplitude (2.0 V).

1. A laser induced thermal embossing (LITE) film, comprising:
a substrate; and
a light-to-heat conversion layer overlaying the substrate, wherein a surface of the LITE film is capable of bearing a microstructured surface selectively embossed thereon.

2. The LITE film of claim 1, further comprising:
a film applied to the light-to-heat conversion layer; and
a material between the film and the light-to-heat conversion layer,
wherein the LITE film comprises a liner that causes structuring of the material via application of the microstructured surface of the light-to-heat conversion layer.

3. The LITE film of claim 1, wherein the light-to-heat conversion layer comprises one of the following: at least one of a metal, a pigment or a dye.

4. The LITE film of claim 1, wherein the light-to-heat conversion layer has a thickness from about 0.01 micron to about 10 microns.

5. The LITE film of claim 1, wherein the microstructured surface has discontinuous microstructured features.

6. The LITE film of claim 1, wherein the microstructured surface has nanostructured features.

7. The LITE film of claim 1, wherein the microstructured surface has microstructured optical elements.

8. The LITE film of claim 1, wherein the microstructured surface has microstructured prisms.

9. A method of fabricating a microreplication tool, comprising:
providing a laser induced thermal embossing (LITE) film comprising a substrate and a light-to-heat conversion layer overlaying the substrate;
laminating the LITE film to a master tool comprising a pattern of microstructures with the light-to-heat conversion layer being in contact with the microstructures;
pattern-wise imaging the LITE film to selectively expose the light-to-heat conversion layer; and
removing the master tool to produce a microstructured pattern on the LITE film corresponding with the microstructures of the master tool.

10. The method of claim 9, further comprising applying a transfer layer to the light-to-heat conversion layer.

11. The method of claim 9, wherein the providing step includes providing the LITE film with the light-to-heat conversion layer comprising one of the following: at least one of a metal, a pigment or a dye.

12. The method of claim 9, wherein the providing step includes providing the LITE film with the light-to-heat conversion layer comprising a nanostructured surface.

13. A method of fabricating a microreplication tool, comprising:
providing a laser induced thermal embossing (LITE) film comprising a substrate and a light-to-heat conversion layer overlaying the substrate;
laminating the LITE film to a first master tool comprising a first pattern of microstructures with the light-to-heat conversion layer being in contact with the first pattern of microstructures;
pattern-wise imaging the LITE film to selectively expose the light-to-heat conversion layer to the first pattern of microstructures;
removing the LITE film from the first master tool;
laminating the LITE film to second master tool comprising a second pattern of microstructures with the light-to-heat conversion layer being in contact with the second pattern of microstructures;
pattern-wise imaging the LITE film to selectively expose the light-to-heat conversion layer to the second pattern of microstructures; and
removing the LITE film from the second master tool to produce the LITE film bearing a pattern corresponding with a combination of the first and second pattern of micro structures.

14. The method of claim 13, further comprising applying a transfer layer to the light-to-heat conversion layer.

15. The method of claim 13, wherein the providing step includes providing the LITE film with the light-to-heat conversion layer comprising one of the following: at least one of a metal, a pigment or a dye.

16. The method of claim 13, wherein the providing step includes providing the LITE film with the light-to-heat conversion layer comprising a nanostructured surface.

17. The method of claim 13, wherein the first pattern of microstructures is different from the second pattern of microstructures.

18. The method of claim 13, wherein the pattern-wise imaging steps include imaging the LITE film first pattern of microstructures at a non-zero angle with respect to the second pattern of microstructures.

19. The method of claim 13, wherein the first and second pattern of microstructures each comprise an array of microstructured prisms.

20. The method of claim 19, wherein the array of microstructured prisms in the first pattern of microstructures has a different pitch than the array of microstructured prisms in the second pattern of microstructures.

21. A laser induced thermal embossing (LITE) film used to make a thermal donor film, comprising:
a substrate;
a light-to-heat conversion layer overlaying the substrate, wherein a surface of the LITE film is capable of bearing a microstructured surface selectively embossed thereon; and
a transfer layer applied to the surface of the light-to-heat conversion layer capable of bearing the microstructured surface,
wherein the LITE film, when irradiated while held in intimate contact with a receptor with the transfer layer held against the receptor, causes transfer of a portion of the transfer layer to the receptor.

22. A method of making a thermal donor film with a structured transfer layer, comprising:
providing a laser induced thermal embossing (LITE) film comprising a substrate and a light-to-heat conversion layer overlaying the substrate;
laminating the LITE film to a master tool comprising a pattern of microstructures with the light-to-heat conversion layer being in contact with the microstructures;
pattern-wise imaging the LITE film to selectively expose the light-to-heat conversion layer;
removing the master tool to produce a microstructured pattern on the LITE film corresponding with the microstructures of the master tool; and
applying a transfer layer to the microstructured pattern on the LITE film,
wherein the LITE film, when irradiated while held in intimate contact with a receptor with the transfer layer held against the receptor, causes transfer of a portion of the transfer layer to the receptor.
